(19) United States
(12) Patent Application Publication
(10) Pub. No.: US 2009/0026753 A1
(43) Pub. Date: Jan. 29, 2009

(54) SECURITY DETERRENT MARK AND METHODS OF FORMING THE SAME

(76) Inventors: Steven J. Simske, Ft. Collins, CO (US); Guy de Warrenne Adams, Stroud (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/829,908

(22) Filed: Jul. 28, 2007

(51) Int. Cl. B42D 15/00

(52) U.S. Cl. 283/70; 283/114; 283/72; 283/74

(57) ABSTRACT

A security deterrent mark includes one or more areas of interest, and at least one entropy-enhancing region within the one or more areas of interest.

### BACKGROUND

The present disclosure relates generally to security deterrent marks and methods of forming the same.

Security printing and publishing is an important component of product differentiation, tracking and authenticating, as well as of anti-counterfeiting initiatives. Security printing involves providing each package with a unique ID, in the form of, for example, a deterrent or mark. Such unique identifiers may be overt and/or covert, and may contain authenticable data. Since unique identifiers compete with branding, sales information, or other product information for real estate on the packaging, it may also be desirable to include multiple levels of security and functionality.

Color tiles are one example of deterrents that have served multiple roles in branding and security, with overt, covert and/or forensic aspects to their deterrence. Color tiles have been used, in some instances, as information carriers, in conjunction with microtext (see for example, U.S. patent application Ser. No. 11/076,534, filed Mar. 8, 2005 (U.S. Patent Publication No. 2006/0202470, published Sep. 14, 2006), incorporated herein by reference in its entirety), and as a means for device-scalable inspection and authentication.

### BRIEF DESCRIPTION OF THE DRAWINGS

Features and advantages of embodiments of the present disclosure will become apparent by reference to the following detailed description and drawings, in which like reference numerals correspond to similar, though not necessarily identical, components. For the sake of brevity, reference numerals having a previously described function may not necessarily be described in connection with subsequent drawings in which they appear.

FIG. 1 is a schematic view of an embodiment of an object having multiple security deterrent marks, at least some of which include an area of interest and at least one entropy-enhancing region;

FIG. 2A is a flow diagram of an embodiment of a method for creating a security deterrent mark;

FIG. 2B is a flow diagram of an embodiment of a system and method for creating a security deterrent mark;

FIG. 3A is a schematic view of an embodiment of a color tile after a single print and scan cycle;

FIG. 3B is a histogram illustrating the effect of the single print and scan cycle on the entropy for two consecutive yellow tiles in the color tile of FIG. 3A;

FIG. 4 is a graph depicting an embodiment of an intentional entropy pattern with a linear window of 4 bins;

FIGS. 5A and 5B depict embodiments of the security deterrent mark including entropy-enhancing regions; and

FIG. 6 depicts another embodiment of a security deterrent mark having at least two different areas of interest.

### DETAILED DESCRIPTION

Embodiments of the deterrents disclosed herein are advantageously useful as copy detection deterrents, which are generally not robust to copying. It is believed that enhanced entropy in one or more areas of the deterrent provide such copy detection. The deterrents are capable of simultaneously providing multiple security levels including, but not limited to a unique identifying sequence, a copy-deterrent, a security key and payload (which advantageously provides a distinct set of information from the unique identifying sequence), and/or a hybrid instrument. Embodiments of the deterrent are also suitable for one or more of track and trace, authentication, device validation, scalable inspection/authentication, and/or chaining/hybridization to other features on the document/package.

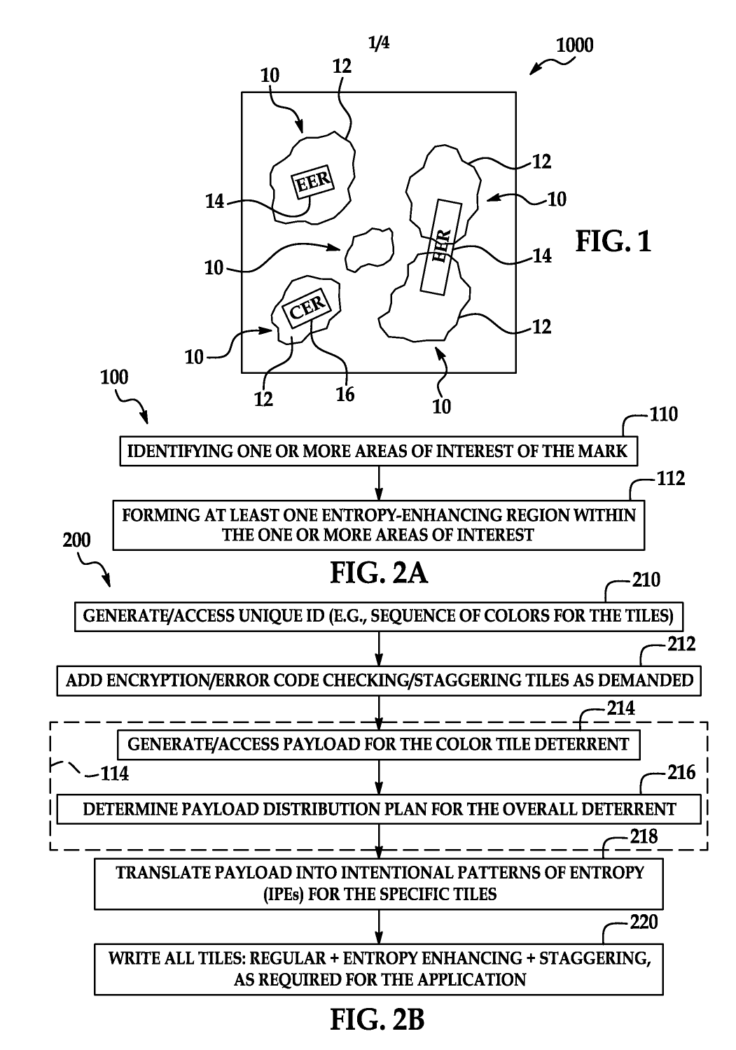

Referring now to FIG. 1, an embodiment of an object 1000 having numerous security deterrent marks 10 established thereon is depicted. It is to be understood that the term “object” as used herein is to be interpreted broadly and may include, but is not limited to any type of object, product, or package. Likewise, the term “package” is to be interpreted broadly herein to include any unit for containing a product, displaying a product, or otherwise identifying a branded good. Non-limitative examples of such packages include boxes, bags, containers, clamshells, bands, tape, wraps, ties, bottles, vials, dispensers, inserts, other documents, or the like, or combinations thereof.

At least one of the security deterrent marks 10 on the object 1000 includes one or more areas of interest 12, and at least one entropy enhancing region EER 14 within one or more of the area(s) of interest 12. It is to be understood that in some embodiments, the area of interest 12 is a portion of the mark 10 (see, for example, FIGS. 8A and 8B), and in other embodiments, the area of interest 12 is the entire mark 10 (see, for example, FIG. 1).

The mark 10 may be selected from any shape or form that is capable of supporting an entropy payload. Generally, suitable marks 10 have a region with a spot color, i.e., a single RGB combination. Non-limiting examples of such marks 10 include color lines, fingerprint patterns, color text, copy detection patterns (CDP), color tiles, letter sequences, number sequences, graphic sequences, target patterns, bar codes, and the like, and combinations thereof. As previously stated, the area of interest 12 is generally all or a portion of the mark 10. It is contemplated as being within the purview of the present disclosure that the marks 10 and/or the area(s) of interest 12 may be variable, i.e., the mark(s) 10 and/or area(s) of interest 12 on one object 1000 are different than one or more mark(s) 10 and/or areas of interest 12 on any other object 1000. Furthermore, it is to be understood that any combination of the types of marks 10 and/or areas of interest 12 may be incorporated on an object 1000.

As non-limiting examples, the mark 10 and the area(s) of interest 12 may be formed of inkjet inks, spectrally opaque ink, spectrally transparent ink, ultraviolet ink, infrared ink, thermochromatic ink, electrochromatic ink, electroluminescent ink, conductive ink, magnetic ink, color-shifting ink, quantum dot ink, phosphorescent ink, and combinations thereof.

It is to be understood that any of the area(s) of interest 12 may contain information. In some embodiments, the information hidden within the area(s) of interest 12 is authenticating information, security information, or both. The information hidden within an area of interest 12 may be for tracking, branding, or the like, or various combinations thereof. In other embodiments, the information hidden within an area of interest 12 is decoy information meant to mislead an unintended recipient of that information. In still other embodiments, no information is hidden within the area(s) of interest 12. It is also to be understood that a single area of interest 12 may have hidden therein any combination of the above, as desired; for example, an area of interest 12 may have hidden therein authenticating, security and tracking information, as well as some decoy information.

Further, it is to be understood that the information may be, for example, a code; a sequence of bits, bytes, characters, colors, graphics, numbers, etc.; a watermark; symbols; interpretable information; a fingerprint(s); other biometric data (e.g., encoded, encrypted, scrambled, chained to other information); a “payload” (discussed further hereinbelow), which may be associated with an entropy pattern; modulation transfer functions (e.g., used in conjunction with a target pattern); or the like; or combinations thereof. A payload is usually a short (8-32 bit) message stored in the area(s) of interest 12. Examples of area(s) of interest 12, information contained within such area(s) of interest 12, or combinations thereof are described further in the following patent applications, each of which is incorporated herein by reference in its entirety: U.S. patent application Ser. Nos. 11/465,763 filed Aug. 18, 2006; 11/414,113 filed Apr. 28, 2006; 11/076,534 filed Mar. 8, 2005 (U.S. Patent Publication No. 2006/0202470, published Sep. 14, 2006); and 11/192,878 filed Jul. 29, 2005 (U.S. Patent Publication No. 2007/0024915, published Feb. 1, 2007).

As briefly referenced above, some area(s) of interest 12 may be decoy areas which appear to contain information (e.g., a barcode), when, in reality, it contains no information or misleading information. A decoy area may also be capable of providing authenticating/security capabilities for some authenticating systems, but is not used in a particular security deterrent mark 10 of interest. As such, in an embodiment, the primary (or sole) purpose of a decoy area may be to evade a potential counterfeiter, to allow for the nature of the information to be altered without changing the in-place marks 10, or combinations thereof. Intentionally inactive marks 10 are further described in U.S. patent application Ser. No. 11/264,179 filed Nov. 1, 2005 (U.S. Patent Publication No. 2007/0096865, published May 3, 2007), which is incorporated herein by reference in its entirety.

As shown in FIG. 1, the entropy-enhancing region EER 14 may be located within one area of interest 12 or may extend over two or more areas of interest 12. Some embodiments of the security deterrent mark 10 including the entropy-enhancing region EER 14 are deployed as a fully-readable deterrent. It is to be understood that the entropy-enhancing region EER 14 and methods of forming the same are discussed further hereinbelow in relation to the other figures.

The embodiment shown in FIG. 1 may also include a chroma-enhancing region CER 16 within one of the areas of interest 12. As with EER 14, it is to be understood that the chroma-enhancing region CER 16 may be included in any number of areas of interest 12, or spanning more than one area of interest 12. A non-limiting example of a chroma-enhancing region is a chroma-enhancing tile in a color tile array. The combination of EER 14 and CER 16 may be used together in a security deterrent mark 10 when the mark 10 is deployed as a scalably-readable deterrent. Chroma-enhancing regions CER 16 are further described in U.S. patent application Ser. No. 11/709,407, filed Feb. 21, 2007, incorporated herein by reference in its entirety.

Referring now to FIGS. 2A and 2B together, an embodiment of a method 100 for forming a security deterrent mark 10 includes identifying one or more areas of interest 12 of the mark 10, as depicted at 110. The method further includes forming at least one entropy-enhancing region 14 within the one or more areas of interest 12, as depicted at 112. In an embodiment, identifying the one or more areas of interest 12 may include generating a payload for the mark 10, and distributing the payload in the one or more areas of interest 12, as depicted at 114 in FIG. 2B.

In an embodiment, forming the at least one entropy-enhancing region 14 may include translating the distributed payload into intentional patterns of entropy, as depicted at 218 in FIG. 2B. Embodiments of the method may further include printing the mark 10, as depicted at 220 in FIG. 2B.

In a further embodiment, prior to identifying the one or more areas of interest 12, the method may further include generating the mark 10, as depicted at 210 in FIG. 2B; and one or more of: i) adding encryption to the mark, ii) error code checking the mark, and iii) staggering individual components of the mark, as depicted at 212 in FIG. 2B.

Referring further to FIG. 2B, an embodiment of a system 200 for creating the security deterrent mark 10 includes a mark generating system 210, a mark manipulating system 212, a payload generating system 214, a payload distributing system 216, a translating system 218, and a printing system 220. It is to be understood that the systems 210, 212, 214, 216, 218 and 220 within the creation system 200 may be configured as a computer program, an Internet enabled program, or the like. Generally, the various systems 210, 212, 214, 216, 218 and 220 are operatively connected or configured so as to function as a single security deterrent mark 10 creation system 200.

The mark generating system 210 enables formation of a unique mark 10 (e.g., a sequence of colors for a color tile array). It is to be understood that any suitable mark 10 may be selected or generated. As a non-limiting example, the mark 10 is a color tile array. In this example embodiment, it is to be understood that the mark generating system 210 allows a unique sequence of colors for the array to be selected.

The mark manipulating system 212 enables encryption, scrambling, error code checking, and/or staggering of one or more regions of the mark 10. It is to be understood that the mark manipulating system 212 is not limited to these particular manipulations. In some embodiments, the mark manipulating system 212 is also capable of associating different shapes with different bit sequences, even as a Huffman code. As a non-limiting example, if 256 different patterns/entropy enhancing region EER 14 combinations are included, then each shape may encode 8 bits by itself. The density of the information added by the entropy enhancing region EER 14 is determined by the ability of the different EER patterns to be disambiguated.

While different levels of entropy within an intentional pattern of entropy may be differentiated, it is observed that differences in patterns themselves may provide a greater payload density than differences in entropy levels. This may be due, at least in part, to the fact that entropy results from a print and scan process. The relative utility of pattern configuration and entropy pattern is dependent on the printing and scanning technologies and processes, in general.

One application of the embedded entropy patterns is to include multiple exactly matched entropy patterns in different areas of interest 12 in the mark 10. It is believed that this enables the greatest difference in entropy between entropy enhanced regions EER 14 and non-enhanced regions. In one embodiment, the difference may be compared to a threshold to determine if the entropy enhanced regions EER 14 are sufficiently matched.

The payload generating system 214 enables formation of a payload that is suitable for the mark 10. As previously described, a payload is usually a short (8-32 bit) message. The payload distributing system 216 determines which area(s) of interest 12 of the mark 10 are desirable for the payload, and distributes the payload accordingly.

The translating system 218 enables the distributed payload to be translated into intentional patterns of entropy; and the printing system 220 enables the final mark 10 (including entropy-enhanced regions EER 14 and non-entropy enhanced regions) to be printed.

The entropy (e) of an image is defined as:

e=−Σpₖ*ln(pₖ) (1).

For a 1-byte intensity raster, k=0 . . . 255, where pₖ=(# pixels in the k^{th} bin)/(# pixels in the entire histogram). From L'Hopital's rule, when pₖ=0, then pₖ*ln(pₖ)=0. Generally, pₖ=x, and the limit of x*ln(x) as x approaches 0 is the limit of ln(x)/x−1 as x approaches 0, and is the limit of [d(ln(x))/dx]/[d(x−1)/dx] as x approaches 0, and thus is [x−1]/[−x−2] or −x, thus 0. It is to be understood that empty histogram bins do not contribute to entropy.

Entropy may be introduced by printing and scanning, and may be enhanced using intentional patterns of entropy (IPE). As a non-limiting example, a substantially uniform color tile (i.e., a color tile with a single hue across the entire tile) has an entropy of 0.0, whereas a random set of intensities has an entropy of 5.545 (for a 256-bin histogram). In an embodiment, an area of interest 12 with an intentional pattern of entropy (IPE) will have an entropy somewhere between these two extremes. It is to be understood that the entropy for each IPE may be different, and that the entropy differential may be used to encode information in a particular area of interest 12.

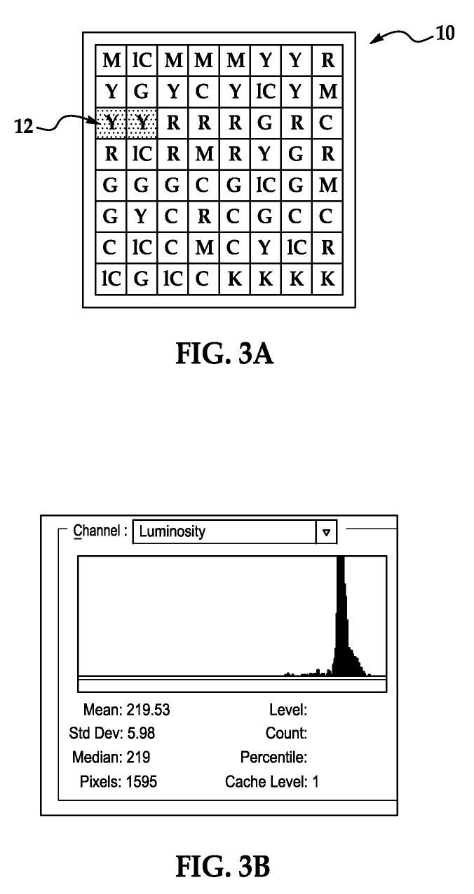

The effect of a single round-trip on the entropy of a uniform color tile is shown in FIGS. 3A and 3B. A schematic color tile security deterrent mark 10 (FIG. 3A) and the histogram (FIG. 3B) for two consecutive yellow (Y) tiles (highlighted in FIG. 3A) are depicted. The color tile mark 10 shown in FIG. 3A includes 8×8 sub-tiles, each of which has a letter representing the sub-tile color (e.g., magenta=M, red=R, cyan=C, light cyan=IC, yellow=Y, green=G, and black=K). It is to be understood that the black sub-tiles and the white outline around the mark 10 may be used for orientation and background.

Non-enhanced entropy yellow tiles generally have low entropy, theoretically 0.0, but more likely 0.2-0.4 due, at least in part, to half-toning and other print preparation effects. It is believed that this is due to the fact that yellow is generally highly saturated in the red and green channels. It is further believed that other colors may have a higher amount of entropy added by the printing process. The mark 10 shown in FIG. 3A is the schematic representation of a single round-trip using, for example, an HP DeskJet 130 for printing and an HP 8200 ScanJet for scanning (all at 600 pixels/inch). The resulting entropy of the yellow tiles is about 2.876 (using the intensity channel of the image), or roughly 50% of the peak entropy (5.545). This entropy level is roughly equivalent to an intentional entropy with a linear window of 51 bins.

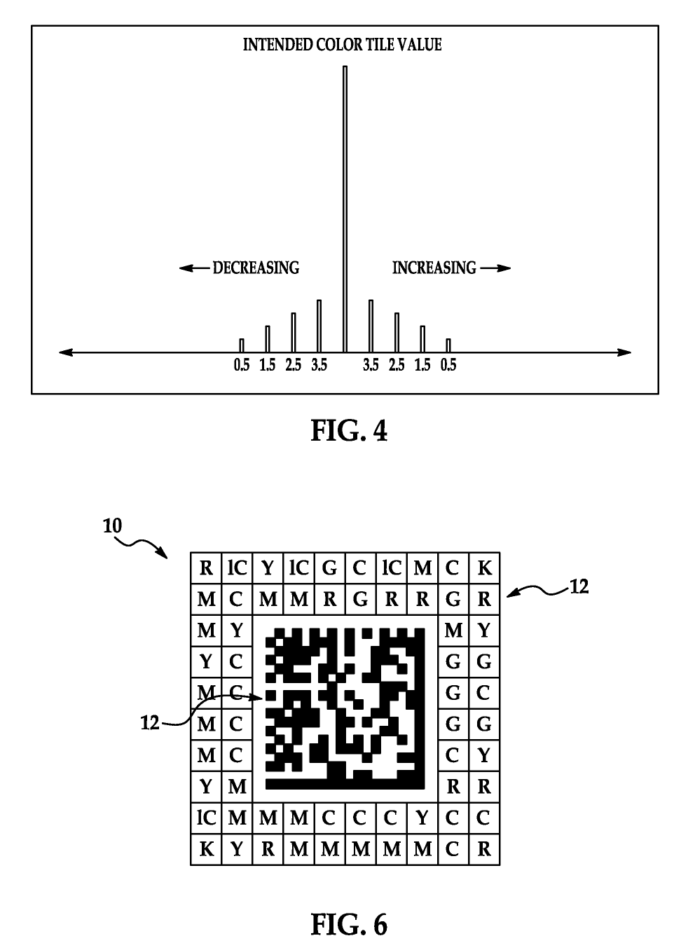

FIG. 4 illustrates an embodiment of an intentional entropy pattern with a linear window of 4 bins. The center peak in FIG. 4 corresponds to a uniform color tile, while the 0.5, 1.5, 2.5 and 3.5 are multiplied by a desirable coefficient, k, to provide the desirable distribution. If the uniform color tiles make up 50% of the overall mark 10, then k=50%/[2*(0.5+1.5+2.5+3.5)]=3.125%. This histogram has an entropy of 1.646, and the equation for the entropy of the curve is:

Entropy=0.5*ln(0.5)+Σ_{i=1.4}[((i−0.5)/32)*ln((i−0.5)/32)].

The intended chroma (color, hue) of the color tile is generally the peak in the center. Intensity/saturation/hue increases to the right, and intensity/saturation/hue decreases to the left. An intentional pattern of entropy is generally symmetrical around the intended value (hue, saturation or intensity). In an embodiment, hue is selected as the intended value, in part because a standard color tile deterrent may include a full-saturated complement of the six colors RGBCMY.

While FIG. 4 illustrates a relatively simple linear window, it is to be understood that a wide variety of basis functions may be selected for the IPE. Generally, the basis function should decrease as the distance from the intended value increases, and should provide a predictable image entropy.

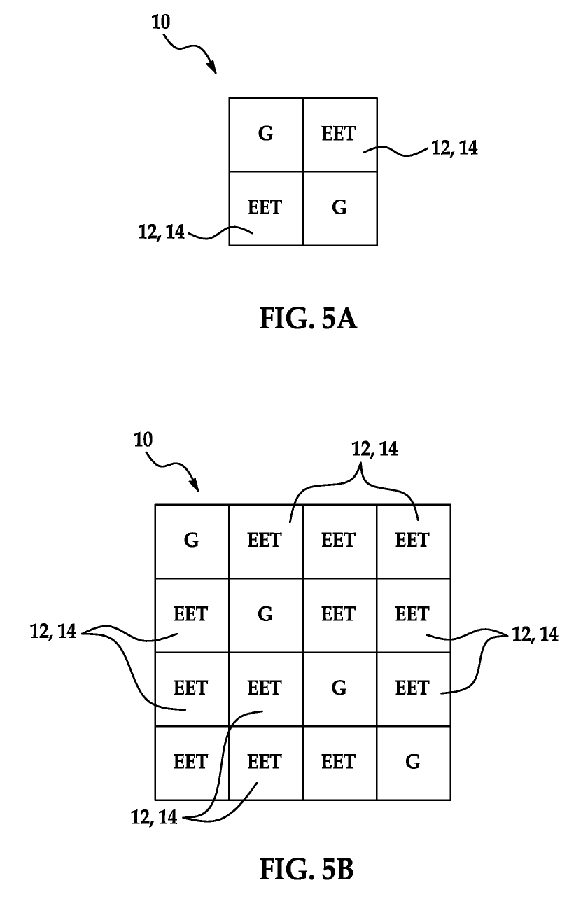

FIGS. 5A and 5B illustrate two embodiments of security deterrent marks 10 including areas of interest 12 having entropy-enhancing regions EER 14 therein.

FIG. 5A illustrates a relatively basic configuration for a color tile security deterrent mark 10 with entropy-enhancing regions EER 14 located within two areas of interest 12. The non-enhanced color tiles, labeled G for a green color, are assigned to two of the four sub-tiles in the 2×2 mark 10. It is to be understood that the mean color of the entropy-enhanced regions EER 14 may be the same color as the non-enhanced color tiles G.

FIG. 5B illustrates a 4×4 sub-tile security deterrent mark 10. In this embodiment, there are four non-enhanced color tiles (again labeled G), and twelve areas of interest 12 with entropy-enhancing regions EER 14 therein. The overall entropy for the embodiment shown in FIG. 5B is different than that of the embodiment shown in FIG. 5A, in part because of the increase in entropy-enhancing regions EER 14 in the mark 10 of FIG. 5B.

It is to be understood that the color tile schemes (marks 10) shown in FIGS. 5A and 5B may be used with varying widths for the linear window (described in reference to FIG. 4). Table 1 illustrates the entropy for eight different window widths for the embodiment shown in FIG. 5A. The entropy represents intentional entropy configurations with 50% of the pixels at the exact color of the pure, non-enhanced color tiles (of FIG. 5A), and the rest (entropy-enhanced tiles) distributed with a linear window of width 1, 2, 4, 8, 16, 32, 64 or 128.

TABLE 1
Window Width and Corresponding Entropy for FIG. 5A

| Window Width | Entropy (e) |
|---|---|
| 1 | 1.040 |
| 2 | 1.321 |
| 4 | 1.646 |
| 8 | 1.986 |
| 16 | 2.330 |
| 32 | 2.676 |
| 64 | 3.023 |
| 128 | 3.369 |

Table 2 illustrates the entropy for eight different window widths for the embodiment shown in FIG. 5B. The entropy represents intentional entropy configurations with 25% of the pixels at the exact color of the pure, non-enhanced color tiles (of FIG. 5B), and the rest (entropy-enhanced tiles) distributed with a linear window of width 1, 2, 4, 8, 16, 32, 64 or 128.

TABLE 2
Window Width and Corresponding Entropy for FIG. 5B

| Window Width | Entropy (e) |
|---|---|
| 1 | 1.082 |
| 2 | 1.504 |
| 4 | 1.991 |
| 8 | 2.501 |
| 16 | 3.018 |
| 32 | 3.537 |
| 64 | 4.057 |
| 128 | 4.576 |

The entropy for the embodiment of the mark 10 shown in FIG. 5B (see Table 2) is substantially increased when compared to that for the mark 10 in FIG. 5A (see Table 1), even when the entropy-enhancing region EER 14 is printed with the same level of variation (i.e., changing window width). This is due, at least in part, to the greater relative amount of entropy-enhanced regions EER 14 present in the embodiment of FIG. 5B.

Different intentional patterns of entropy (IPE) may be used as a secret key for the security deterrent mark 10. N different IPEs may be successfully distinguished (e.g., the 8 different IPEs in Table 1 or Table 2 may be distinguished if the final variances after addition of SRT entropy is such that the 1, 2, 4, 8, 16, 32, 64 and 128 windows do not overlap). These N different IPEs may be toggled through in N! (N factorial) ways, which allows for distributed error code checking throughout the color tile deterrent. If there are 6 colors (e.g., RGBCMY), then there are (N!)⁶ different payloads. If, for example, N=4, this is (4!)⁶=(24)⁶, which corresponds to more than 27 bits, or nearly 3.5 bytes of information. If, for example, N=5, this is (120)⁶, or just over 5 bytes of information.

As such, in the embodiment in which the mark 10 is a color tile, the payload is specified by the variation in the entropy in the color tile, rather than by the color itself. This allows a secret key to be embedded that is distinct from the sequence of tiles itself. Other means for embedding a secret key are contemplated as being suitable for use herein, including a simple sub-deterrent sequence that is replicated in chunks around the deterrent mark 10 (e.g., as 4×4 tile blocks in a larger, for example 16×16 tile, overall deterrent). In this non-limiting example, there are N¹⁶ different payloads possible (i.e., 4 bytes of information for N=4, and 4.5 bytes of information for N=5).

Both FIGS. 5A and 5B illustrate staggered non-enhanced tiles G. It is to be understood, however, that the non-enhanced regions G of the mark 10 may also be linear or non-contiguous. Furthermore, the embodiments are shown as being square. Such color tile marks 10 may be rectangular, diamond shaped, or any other suitable geometry, as desired.

FIG. 6 depicts still another embodiment of a security deterrent mark 10. This embodiment includes at least two potential areas of interest 12, the color tiles as a whole, and the black and white tiles as a whole. It is to be understood that each sub-tile itself may also be an area of interest 12. As such, the mark 10 shown in FIG. 6 has the potential to contain few or many areas of interest 12, as is desirable.

For any of the embodiments disclosed herein, the areas of interest 12 and/or information contained therein may be chained together to produce a hybrid or combination instrument. A non-limiting example of such a hybrid or combination instrument includes one area of interest 12 (whose overt appearance is difficult to reproduce) chained to another area of interest 12 (whose hidden information (e.g., weak watermarks, guilloches, or the like, or combinations thereof)) is difficult to copy.

While several embodiments have been described in detail, it will be apparent to those skilled in the art that the disclosed embodiments may be modified. Therefore, the foregoing description is to be considered exemplary rather than limiting.

What is claimed is:

1. A security deterrent mark, comprising:
one or more areas of interest; and
at least one entropy-enhancing region within the one or more areas of interest.

2. A security deterrent mark as defined in claim 1, further comprising at least one chroma-enhancing region within the area of interest.

3. The security deterrent mark as defined in claim 2 wherein the mark is scalably-readable.

4. The security deterrent mark as defined in claim 1 wherein the mark is fully readable.

5. The security deterrent mark as defined in claim 1 wherein a secure key is used to access a payload in the mark for authentication.

6. The security deterrent mark as defined in claim 1 wherein the mark is a unique identification mark, a copy deterrent, security key evidence, a hybrid instrument, or combinations thereof.

7. The security deterrent mark as defined in claim 1, further comprising an intentional pattern of entropy in the at least one entropy-enhancing region.

8. The security deterrent mark as defined in claim 1 wherein at least one of the one or more areas of interest is a color tile array.

9. The security deterrent mark as defined in claim 8 wherein the at least one entropy-enhancing region is at least one entropy-enhancing tile in the color tile array.

10. The security deterrent mark as defined in claim 1 wherein an entropy in the at least one entropy-enhancing region ranges from about 1 to about 6.

11. The security deterrent mark as defined in claim 1 wherein the one or more areas of interest has a region with a spot color, and is at least a portion of color lines, fingerprint patterns, color text, copy detection patterns, color tiles, letter sequences, number sequences, graphic sequences, target patterns, bar codes, or combinations thereof.

12. A method for forming a security deterrent mark, comprising:
identifying one or more areas of interest of the mark; and
forming at least one entropy-enhancing region within the one or more areas of interest.

13. The method as defined in claim 12 wherein identifying the one or more areas of interest includes:
generating a payload for the mark; and
distributing the payload in the one or more areas of interest.

14. The method as defined in claim 13 wherein forming the at least one entropy-enhancing region includes translating the distributed payload into intentional patterns of entropy.

15. The method as defined in claim 14 wherein the mark is a color tile sequence, and wherein the intentional patterns of entropy are present in a predetermined number of color tiles in the sequence.

16. The method as defined in claim 12, further comprising printing the mark.

17. The method as defined in claim 12 wherein prior to identifying the one or more areas of interest, the method further comprises:
generating the mark; and
one or more of: i) adding encryption to the mark, ii) error code checking the mark, and iii) staggering individual components of the mark.

18. A system for creating a security deterrent mark, comprising:
means for generating the mark;
means for identifying one or more areas of interest of the mark; and
means for forming at least one entropy-enhancing region within the one or more areas of interest.

19. The system as defined in claim 18 wherein the identifying means includes:
means for generating a payload for the mark; and
means for distributing the payload in the one or more areas of interest.

20. The system as defined in claim 18 wherein the forming means includes means for translating the distributed payload into intentional patterns of entropy.
